(19) United States
(12) Patent Application Publication
(10) Pub. No.: US 2022/0337918 A1
(43) Pub. Date: Oct. 20, 2022

(54) SYSTEM, METHOD, AND COMPUTER-READABLE MEDIUM INCLUDING PROGRAM FOR GENERATING CONTENT

(71) Applicant: DeNA Co., Ltd., Tokyo (JP)

(72) Inventor: Kazuto Shibata, Tokyo (JP)

(73) Assignee: DeNA Co., Ltd., Tokyo (JP)

(21) Appl. No.: 17/718,657

(22) Filed: Apr. 12, 2022

(30) Foreign Application Priority Data
Apr. 14, 2021 (JP) 2021-068521

(51) Int. Cl. H04N 21/81; H04N 21/4788; H04N 21/2187

(52) U.S. Cl. CPC H04N 21/8133; H04N 21/4788; H04N 21/2187

(57) ABSTRACT

A video distribution server according to an embodiment of the present invention supports the generation of content in consideration of the relationship between users. The server is communicably connected to a user terminal via a communication network and provides a video distribution service for distributing and viewing a video to a user via the user terminal. The server generates the message content including a plurality of messages for the distributor input by the viewer based on the value of the relationship parameter related to the relationship between the viewer and the distributor. Therefore, the generated message content takes the relationship between the viewer and the distributor into consideration.

### CROSS-REFERENCE TO RELATED APPLICATIONS

The present application claims the benefit of Japanese Patent Application No. JP2021-068521, filed on Apr. 14, 2021, the content of which is incorporated herein in its entire by reference.

### TECHNICAL FIELD

The present invention relates to a system, a method, and a computer-readable medium including program for generating content.

### BACKGROUND

Conventionally, various services for generating content containing a plurality of messages have been provided. For example, Japanese Patent Application Laid-Open Nos. 2001-297051, 2015-133000, and 2017-138799 disclose a system for electronically realizing a collection of messages in which a plurality of messages from a plurality of participants is included. Such a system promotes the efficient generation of the collection of messages and the improvement of the quality of the generated collection of messages. In addition, content such as a collection of messages can be used as a communication tool between an owner (artist, creator, influencer, and the like) and participants (fans and the like) in a community service.

However, the above-mentioned conventional system does not take the characteristics of community services into consideration, and it may be difficult to apply it as a communication tool in such services. For example, it cannot be said that conventional systems sufficiently take the relationship between the recipient of the collection of messages (for example, the owner of the community) and the participants who participate in generating the collection of messages (for example, the participants in the community) into consideration.

One of the objects of the embodiments of the present invention is to support the generation of content in consideration of the relationship between users. Other objects of the embodiments of the present invention will become apparent by referring to the entire specification.

### SUMMARY

The system according to an embodiment of the present invention is a system including one or more computer processors. The one or more computer processors execute machine-readable instructions to perform managing a value of a predetermined parameter related to a relationship with a first user and associated with each of a plurality of second users; and generating content including a plurality of messages for the first user input by at least some of the plurality of second users. In the system, the generating of the content includes generating the content based on at least the value of the predetermined parameter of at least some of the plurality of second users.

A method according to an embodiment of the present invention is a method executed by one or more computers. The method includes managing a value of a predetermined parameter related to a relationship with a first user and associated with each of a plurality of second users; and generating content including a plurality of messages for the first user input by at least some of the plurality of second users. In the method, the generating of the content includes generating the content based on at least the value of the predetermined parameter of at least some of the plurality of second users.

A non-transitory computer-readable medium according to an embodiment of the present invention includes a program. The program causes one or more computers to execute managing a value of a predetermined parameter related to a relationship with a first user and associated with each of a plurality of second users; and generating content including a plurality of messages for the first user input by at least some of the plurality of second users. In the program, the generating of the content includes generating the content based on at least the value of the predetermined parameter of at least some of the plurality of second users.

Various embodiments of the present invention can support the generation of content in consideration of the relationship between users.

### BRIEF DESCRIPTION OF THE DRAWINGS

FIG. 1 is a configuration diagram schematically showing a configuration of a network including a video distribution server 10 according to an embodiment of the present invention.

FIG. 2 is a block diagram schematically showing the functions of the video distribution server 10.

FIG. 3 is a diagram illustrating information managed in a user information table 411.

FIG. 4 is a diagram for explaining the rank.

FIG. 5 is a diagram illustrating information managed in a distribution management table 412.

FIG. 6 is a diagram illustrating information managed in a relationship parameter management table 413.

FIG. 7 is a diagram illustrating information managed in a content information table 414.

FIG. 8 is a diagram illustrating the type of collection of messages and the corresponding schedule.

FIG. 9 is a diagram illustrating information managed in a message management table 415.

FIG. 10 is a diagram illustrating a top screen 60.

FIG. 11 is a diagram illustrating the display content of an individual display area 641.

FIG. 12 is a diagram illustrating the top screen 60 when “topic” is selected in a selection area 62.

FIG. 13 is a diagram illustrating the display content of an individual display area 642.

FIG. 14 is a diagram illustrating a distribution preparation screen 100.

FIG. 15 is a diagram illustrating a distributor screen 70.

FIG. 16 is a diagram illustrating a viewer screen 80.

FIG. 17 is a diagram illustrating an item selection screen 200.

FIG. 18 is a diagram for explaining each condition of a plurality of fan levels.

FIG. 19 is a flowchart illustrating processes executed by the server 10 when updating the rank.

FIG. 20 is a diagram illustrating the correspondence between the number of special fans and the distribution point bonus (magnification).

FIG. 21 is a diagram for explaining a rule for updating a rank meter value.

FIG. 22 is a diagram for explaining the correspondence between the updated content of the rank and the required rank meter value.

FIG. 23 is a flowchart illustrating processes executed by the server 10 when a diamond is assigned.

FIG. 24 is a diagram illustrating a fan letter screen 300.

FIG. 25 is a diagram illustrating a message editing screen 500.

FIG. 26 is a diagram illustrating a preview screen 600.

FIG. 27 is a diagram illustrating the fan letter screen 300 in which a collection of messages is published.

### DETAILED DESCRIPTION

Hereinafter, embodiments of the present invention will be described with reference to the drawings. In each drawing, the same or similar components may be labeled with the same reference numerals.

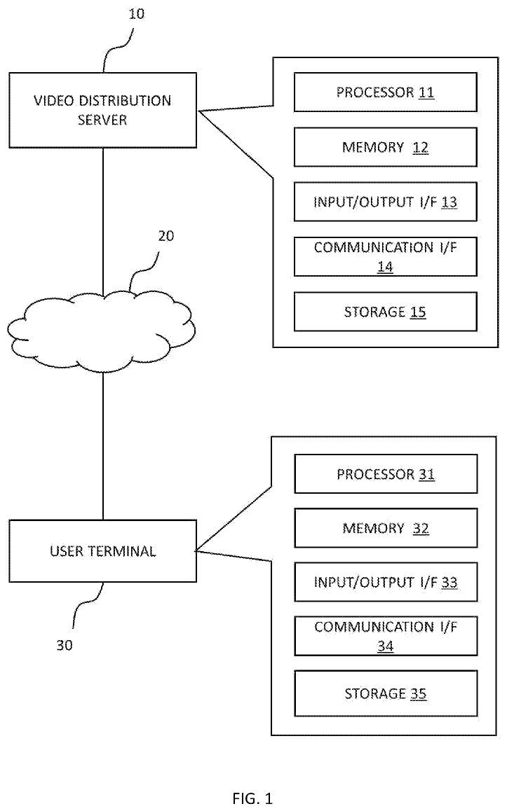

FIG. 1 is a configuration diagram schematically showing a configuration of a network including a video distribution server 10 according to an embodiment of the present invention. As shown in the drawing, the video distribution server 10 is communicably connected to a user terminal 30 via a communication network 20 such as the Internet. Although only one user terminal 30 is shown in FIG. 1, the server 10 is communicably connected to a plurality of user terminals 30. The server 10 provides a video distribution service for distributing and viewing a video to a user via the user terminal 30. In the present embodiment, the user who operates the user terminal 30 can distribute the video as a distributor and can also view the video of another user as a viewer. The video distribution server 10 is an example of a device that implements a part or all of the system of the present invention and has functions for generating content including a plurality of messages.

First, the hardware configuration of the video distribution server 10 will be described. The video distribution server 10 is configured as a general computer, and as shown in FIG. 1, includes a computer processor 11, a main memory 12, an input/output I/F 13, a communication I/F 14, and a storage (storage device) 15, and these components are electrically connected via a bus (not shown) or the like.

The computer processor 11 is configured as a CPU, a GPU, or the like, reads various programs stored in the storage 15 or the like into the main memory 12, and executes various commands included in the programs. The main memory 12 is configured of, for example, a DRAM or the like.

The input/output I/F 13 includes various input/output devices for exchanging information with an operator and the like. The input/output I/F 13 includes, for example, an information input device such as a keyboard and a pointing device (for example, a mouse, a touch panel, and the like), an audio input device such as a microphone, and an image input device such as a camera. Further, the input/output I/F 13 includes an image output device such as a display and an audio output device such as a speaker.

The communication I/F 14 is implemented as hardware such as a network adapter, various pieces of communication software, and a combination thereof, and is configured to realize wired or wireless communication via the communication network 20 or the like.

The storage 15 is configured of, for example, a magnetic disk, a flash memory, or the like. The storage 15 stores various programs including an operating system, various pieces of data, and the like.

In the present embodiment, the video distribution server 10 can be configured using a plurality of computers, each of which has the above-mentioned hardware configuration. For example, the video distribution server 10 may be configured of one or more server devices.

The video distribution server 10 configured in this way can be configured to have functions as a web server and an application server. In this case, the video distribution server 10 executes various processes in response to a request from the web browser and other applications (for example, a video distribution service application) installed on the user terminal 30, and transmits screen data (for example, HTML data) corresponding to the results of the processes, control data, and the like to the user terminal 30. The user terminal 30 may display a web page or other screens on the basis of the received data.

Next, the hardware configuration of the user terminal 30 will be described. The user terminal 30 is configured as a general computer, and as shown in FIG. 1, includes a computer processor 31, a main memory 32, an input/output I/F 33, a communication I/F 34, and a storage (storage device) 35, and these components are electrically connected via a bus (not shown) or the like.

The computer processor 31 is configured as a CPU, a GPU, or the like, reads various programs stored in the storage 35 or the like into the main memory 32, and executes various commands included in the programs. The main memory 32 is configured of, for example, a DRAM or the like.

The input/output I/F 33 includes various input/output devices for exchanging information with an operator and the like. The input/output I/F 33 includes, for example, an information input device such as a keyboard and a pointing device (for example, a mouse, a touch panel, and the like), an audio input device such as a microphone, and an image input device such as a camera. Further, the input/output I/F 33 includes an image output device such as a display and an audio output device such as a speaker.

The communication I/F 34 is implemented as hardware such as a network adapter, various pieces of communication software, and a combination thereof, and is configured to realize wired or wireless communication via the communication network 20 or the like.

The storage 35 is configured of, for example, a magnetic disk, a flash memory, or the like. The storage 35 stores various programs including an operating system, various data, and the like. The program stored in the storage 35 can be downloaded and installed from an application market or the like.

In the present embodiment, the user terminal 30 can be configured as a smartphone, a tablet terminal, a personal computer, a wearable device, and the like.

The user who operates the user terminal 30 configured in this way can use the video distribution service provided by the server 10 by executing communication with the video distribution server 10 via a web browser or other applications installed in the storage 35 or the like.

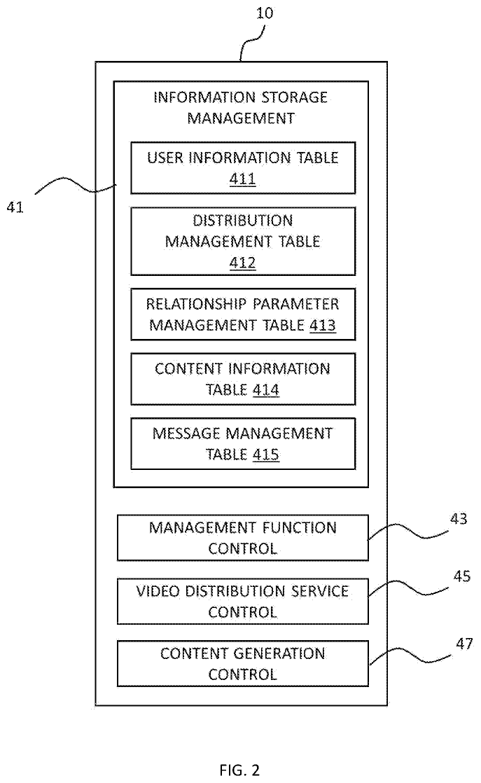

Next, the function of the video distribution server 10 configured in this way will be described. FIG. 2 is a block diagram schematically showing the functions of the video distribution server 10. As shown in the drawing, the server 10 has an information storage manager 41 that stores and manages various pieces of information, a management function controller 43 that controls the management function of the video distribution service, a video distribution service controller 45 that controls the video distribution service, and a content generation controller 47 that controls the generation of message content including a plurality of messages. These functions are realized by the hardware such as the computer processor 11 and the main memory 12 and various programs and data stored in the storage 15 and the like operating in cooperation with each other. For example, the functions are realized by the computer processor 11 executing commands included in the program read into the main memory 12. Further, a part or all of the functions of the server 10 shown in FIG. 2 may be realized by the cooperation of the server 10 and the user terminal 30 or may be realized by the user terminal 30.

The information storage manager 41 is configured to store and manage various pieces of information in the storage 15 and the like. For example, as shown in FIG. 2, the information storage manager 41 has a user information table 411 that manages information on users of a video distribution service, a distribution management table 412 that manages information on individual video distribution, a relationship parameter management table 413 that manages information on a relationship parameter (predetermined parameter) related to the relationship between a distributor and a viewer, a content information table 414 that manages information on the message content, and a message management table 415 that manages information on the individual messages included in the message content.

The management function controller 43 is configured to execute various processes related to the control of the management function of the video distribution service. For example, the management function controller 43 transmits screen data and control data of various screens related to the management function to the user terminal 30, executes various processes in response to an operation input by the user via the screen displayed on the user terminal 30, and transmits screen data, control data, and the like corresponding to the results of the processes to the user terminal 30. The management function controlled by the management function controller 43 includes, for example, login processing (user authentication), billing control, user account management, and the like.

The video distribution service controller 45 is configured to execute various processes related to the control of the video distribution service. For example, the video distribution service controller 45 is configured to distribute the video provided by the distributor to a plurality of viewers. For example, in the case of real-time distribution (live distribution) of a video, the video distribution service controller 45 receives a real-time video transmitted from the user terminal 30 of the distributor (hereinafter, may be referred to as a “distributor terminal 30”) and transmits the video to the user terminals 30 of a plurality of viewers (hereinafter, may be referred to as “viewer terminals 30”). In the viewer terminal 30, the video is displayed (played) on the viewer screen for viewing the video. The real-time video is configured of, for example, an image input through the camera of the distributor terminal 30 and an audio input via a microphone of the distributor terminal 30. Further, the real-time video is configured of, for example, images and audios output via an application (for example, a game application) running on the distributor terminal 30. Such a live distribution of video can be performed by, for example, a streaming method using a protocol such as HTTP Live Streaming (HLS). Further, the video distribution service controller 45 may be configured to record the video provided by the distributor in the storage 15 or the like, and distribute the video in response to individual requests from the viewers.

In the present embodiment, the video distribution service controller 45 is configured to manage the value of the relationship parameter related to the relationship with the distributor (first user) and associated with each of a plurality of viewers (second user). The value of the relationship parameter is managed in the relationship parameter management table 413, for example, in correspondence with the combination of the distributor and the viewer. The relationship parameter can be designed, for example, as a parameter indicating degree of intimacy, friendship, contribution, and the like.

The content generation controller 47 is configured to execute various processes related to the control of the generation of message content. In the present embodiment, the content generation controller 47 is configured to generate message content including a plurality of messages to a distributor based on at least the value of the relationship parameter of each viewer. The plurality of messages to the distributor is input by at least some of the plurality of viewers. The message may be configured, for example, of text, images (still images or videos), and audios, or a combination thereof. The message content is configured as, for example, a “collection of messages”.

As described above, the video distribution server 10 in the present embodiment generates the message content including a plurality of messages to the distributor input by the viewer based on the value of the relationship parameter related to the relationship between the viewer and the distributor. Therefore, the generated message content takes the relationship between the viewer and the distributor into consideration. In this way, the video distribution server 10 supports the generation of content in consideration of the relationship between users.

In the present embodiment, when the message content is generated, the message from a viewer who has a stronger relationship with the distributor may be prioritized. That is, the content generation controller 47 may be configured to generate message content so that the message input by the viewer having a stronger relationship indicated by the value of the relationship parameter is prioritized.

For example, when the value of the relationship parameter is designed to be larger as the relationship is stronger, the message from the viewer having the larger value of the relationship parameter is prioritized. For example, when the value of the relationship parameter is updated to become larger as the video provided by the distributor is viewed more, the message from the viewer having the larger value of the relationship parameter is prioritized. Further, for example, when the value of the relationship parameter is designed to be smaller as the relationship is stronger, the message from the viewer having the smaller value of the relationship parameter is prioritized. Such a configuration enables the generation of content that prioritizes messages from viewers who have a stronger relationship with the distributor. As a result, the viewer can be encouraged to strengthen the relationship with the distributor.

In the present embodiment, the prioritization of the message from the viewer having a stronger relationship with the distributor can be realized in various aspects. For example, the content generation controller 47 may be configured to receive the input of a message by a viewer whose relationship parameter value is within a predetermined range (for example, a predetermined value or more), while not receiving the input of a message by a viewer whose relationship parameter value is outside the predetermined range (for example, less than the predetermined value). For example, a message from a viewer is input via a screen displayed on the viewer terminal 30, and the screen is displayed on the user terminal 30 of a viewer whose relationship parameter value is within the predetermined range, whereas the screen is not displayed on the user terminal 30 of a viewer whose relationship parameter value is outside the predetermined range. Such a configuration enables the generation of content in which only messages from viewers having strong relationship are included.

Further, for example, the content generation controller 47 may be configured to generate message content so that the amount of information (for example, the number of characters, the data capacity, the data size, or the like) of the message input by the viewer having a stronger relationship indicated by the value of the relationship parameter increases. For example, the upper limit of the amount of information of the message input by the viewer whose relationship parameter value is the first value is set to the first quantity, while the upper limit of the amount of information of the message input by the viewer whose relationship parameter value is the second value indicating a stronger relationship than the first value is set to the second quantity, which is larger than the first quantity. Such a configuration enables the generation of content in which the amount of information of a message from a viewer with a stronger relationship becomes larger.

Further, for example, the content generation controller 47 may be configured to generate message content so that a message input by a viewer having a stronger relationship indicated by the value of the relationship parameter is preferentially arranged. For example, a message input by a viewer having a stronger relationship is arranged prominently in the content. For example, the message content is configured as an image or page on which a plurality of messages is arranged, and a message input by a viewer having a stronger relationship is arranged at a prominent position (for example, at the top or center) of the image or page and/or is arranged in a prominent size (for example, the size (area) of the message is increased). Further, when the message is configured as a video or audio and the message content is generated as a combination of a plurality of videos or audios that are continuous in time, the message input by a viewer having a stronger relationship is arranged at a prominent temporal position (for example, the beginning or end) of such content (combination of videos or audios). Such a configuration enables the generation of content in which messages from viewers having a stronger relationship are preferentially arranged.

In the present embodiment, the number of messages that can be input by one viewer may be limited. For example, the content generation controller 47 may be configured to limit the number of messages that can be input by one viewer to within a predetermined value (for example, within a value of 1 or 2 or more). Such a configuration can prevent one viewer from inputting an excessive number of messages.

In the present embodiment, the message from a specific viewer may be excluded. For example, the content generation controller 47 may be configured to generate message content so that messages input by viewers (for example, blocked viewers) set by the distributor to a predetermined state are excluded. For example, the content generation controller 47 may be configured to not receive the input of a message from a viewer set in a predetermined state or ignore the message after receiving the input of the message from such a viewer (the message is not included in the content). Such a configuration enables the generation of content excluding messages from specific viewers.

Further, the content generation controller 47 may be configured to present the generated message content to at least the distributor. For example, the message content is presented to the distributor via a screen displayed on the distributor terminal 30. In addition, the message content may be similarly presented to a viewer (for example, limited to a viewer who has input a message included in the content, or also including a viewer who has not input the message).

In the present embodiment, when the number of viewers who have input the message is small, the message content may not be presented to the distributor. That is, the content generation controller 47 may be configured to stop presenting the message content to the distributor (for example, the content creation itself is stopped, or the presentation of the generated content is stopped) when the number of viewers who have input the message is equal to or less than a predetermined value. Such a configuration prevents the content composed of messages from a very small number of viewers from being presented to the distributor.

Further, the content generation controller 47 may be configured to start receiving the input of the message from the viewer in response to the start of a predetermined period and generate the content including the plurality of messages input by the end of the predetermined period. In this case, for example, the content generation controller 47 is configured to prompt the viewer who has viewed the video during the predetermined period to input a message to the distributor who provides the video. Such a configuration enables the generation of content including a message input in a certain period of time by a viewer.

In the present embodiment, when the number of viewers who have input the message is large, the generated message content may be divided. That is, the content generation controller 47 may be configured to generate divided message content when the number of viewers who have input the message is a predetermined value or more. For example, the generated message content is divided into the first content composed of a plurality of messages from a first viewer group among the plurality of viewers who input the message, and the second content composed of a plurality of messages from a second viewer group (for example, a viewer group having a stronger relationship with the distributor than the first viewer group). Further, for example, the generated message content is divided into the first content composed of a plurality of messages input in a first period and the second content composed of a plurality of messages input in a second period after the first period. Such a configuration prevents messages from an excessive number of viewers from being included in one piece of content.

Next, a specific example as one aspect of the video distribution server 10 of the present embodiment having such a function will be described. The video distribution service in this example is configured as a live distribution service enabling users to distribute and view a live video configured of an image input via the camera of the distributor terminal 30 and an audio input via a microphone of the distributor terminal 30.

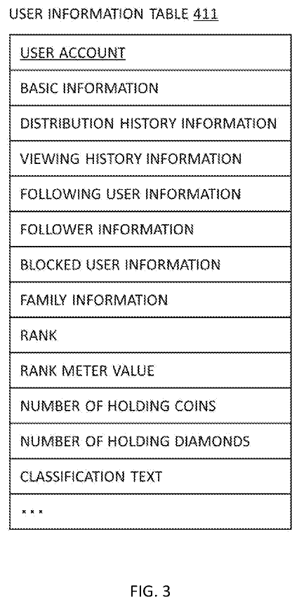

First, the information managed by each table in this example will be described. FIG. 3 illustrates the information managed in the user information table 411 in this example. The user information table 411 manages information on users of the live distribution service, and as shown in the drawing, manages the following information in correspondence with a “user account” that identifies an individual user. The information includes “basic information” including an account name, age, gender, area of residence, and profile information, “distribution history information” which is information on distribution history as a distributor, “viewing history information” which is information on viewing history as a viewer, “following user information” which is information on other users that this user is following, “follower information” which is information on other users (followers) who are following this user, “blocked user information” which is information on other users blocked by this user, “family information” which is information on the family that this user has joined as a family member, “rank” indicating the rank of the user as a distributor, “rank meter value” which is a parameter value for determining whether to increase or decrease the rank, “number of holding coins” indicating the number of virtual holding coins, available in the live distribution service, “number of holding diamonds” indicating the number of virtual holding diamonds, available in the live distribution service, and “classification text” which is the classification set by the user as a distributor.

In this example, the user can set another user in the blocked state (predetermined state), and the blocked user information is set with information (user account, and the like) on the blocked user, who is set in the blocked state. The blocked other users are limited in the actions they can perform on the live distribution of the corresponding user, and for example, are not allowed to input comments while viewing the live distribution.

In this example, the family is a community of fans who support a distributor. Users can join the family in response to an invitation from the distributor or family administrator and can join the family in response to an approval from the distributor or family administrator for a subscription application by the user. Further, in this example, an upper limit value (for example, 100 people) is set for the number of members of the family.

Further, in this example, coins are given to the user free of charge and for a fee on various occasions. For example, the user can earn coins free of charge as a reward for a login bonus or the like. Also, for example, the user can purchase coins (in real currency) for a fee.

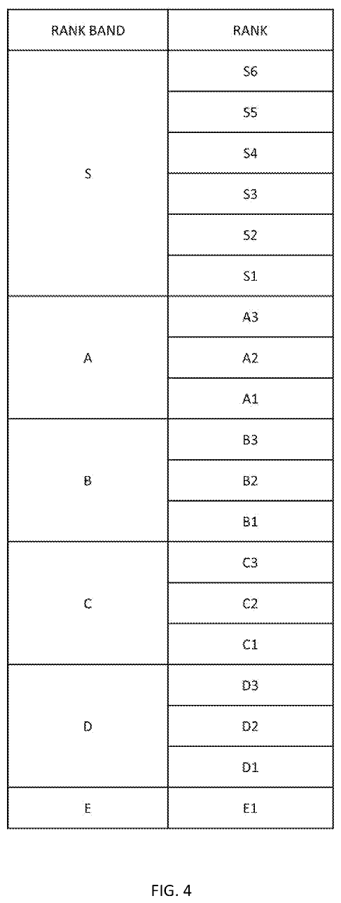

FIG. 4 is a diagram for explaining the “rank” of the distributor in this example. As shown in this example, there are six rank bands of “S”, “A”, “B”, “C”, “D” and “E”. The rank band of “S” has six ranks, and each of the four rank bands of “A”, “B”, “C”, and “D” has three ranks (for example, a rank with a number added to the alphabet indicating the rank band such as “S1” and “A2”). Further, the rank band of “E” includes one rank “E1”. That is, in this example, there are 19 steps (6+3×4+1=19).

Further, in the rank band, the “S” side is the highest and the “E” side is the lowest. Further, in the ranks in the same rank band, the rank is higher as the number added to the rank band is larger and is lower as the number added is smaller. In this example, the user rank is set to “Dl” as an initial value.

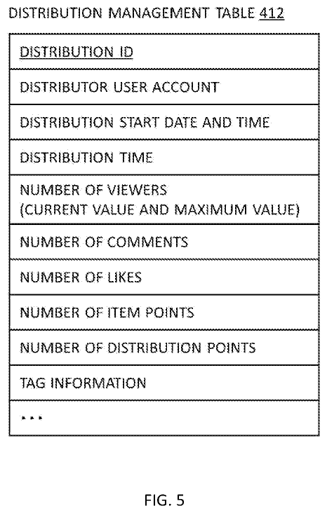

FIG. 5 illustrates the information managed in the distribution management table 412 in this example. The distribution management table 412 manages information on individual live distributions (videos), and as shown in the drawing, manages the following information in correspondence with a “distribution ID” that identifies individual live distributions. The information includes “distributor user account” that identifies a distributor, “distribution start date and time”, “distribution time” indicating the duration of distribution, “number of viewers (current value and maximum value)”, “number of comments” which is the number of comments input by viewers, “number of likes” which is the number of “likes” input by viewers, “number of item points” which increases according to the input of items by viewers, “number of distribution points” which is the point given for this distribution, and “tag information” which is information on the tag given to this distribution.

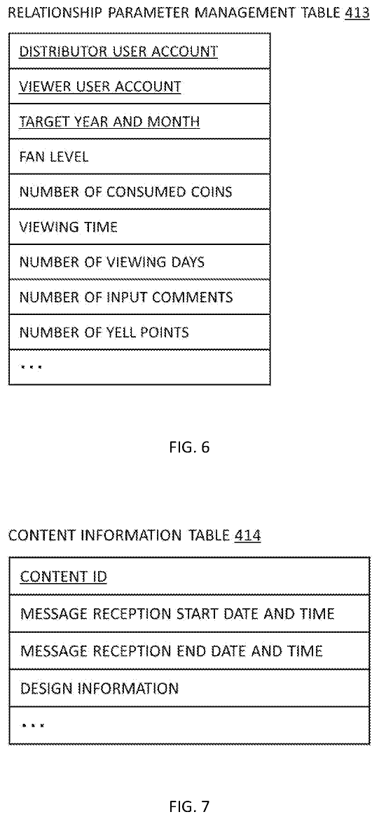

FIG. 6 illustrates the information managed in the relationship parameter management table 413 in this example. The relationship parameter management table 413 manages information on the viewer's fan level (relationship parameter) for the distributor (each distributor) in the target year and month, and as shown in the drawing, manages the following information in correspondence with a combination of “distributor user account” that identifies a distributor, “viewer user account” that identifies a viewer, and “target year and month”. The information includes “fan level” of the corresponding viewer for the corresponding distributor in the target year and month and “number of consumed coins”, “viewing time”, “number of viewing days”, “number of input comments”, and “number of yell points” (relationship parameter) of the viewer for the live distribution of the distributor in the target year and month. In this example, the viewer's fan level for the distributor is managed on a monthly basis.

The number of yell points is calculated using a calculation formula on the basis of the number of consumed coins, the viewing time, the number of viewing days, and the number of input comments. The larger the value of each of these parameters, the larger the value of the number of yell points.

FIG. 7 illustrates the information managed in the content information table 414 in this example. The content information table 414 manages information on “collection of messages” as message content in this example, and as shown in the drawing, manages the following information in correspondence with “content ID” that identifies the type of individual collections of messages. The information includes “message reception start date and time” which is the date and time when the reception of the input of the message for collection of messages is started, “message reception end date and time” which is the date and time when the reception of the input of the message for collection of messages is finished, and “design information” which is the information on the design such as the background of the collection of messages.

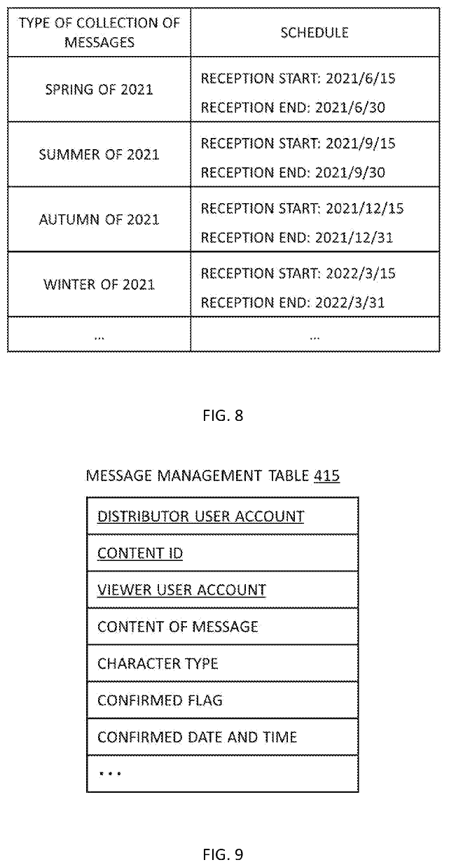

FIG. 8 illustrates the type of collection of messages provided in this example and the corresponding schedule (reception start date and time and reception end date and time of the input of message). In the live distribution service of this example, an event for creating a collection of messages to the distributor is held four times a year, and the collection of messages has a design corresponding to each season. For example, as shown in the drawing, the types of collection of messages corresponding to each of the spring, summer, autumn, and winter of the year 2021 are set in advance, and the corresponding schedule is set for each of these types of collection of messages. For example, for the collection of messages of “summer of 2021”, the reception of message input starts on Sep. 15, 2021, and the reception of message input ends on Sep. 30, 2021. Such information is set in the content information table 414.

FIG. 9 illustrates the information managed in the message management table 415 in this example. The message management table 415 manages information on the message for the collection of messages input by each viewer, and as shown in the drawing, manages the following information in correspondence with a combination of “distributor user account” that identifies the distributor, “content ID” that identifies the type of the collection of messages, and “viewer user account” that identifies the viewer. The information includes “content of message” which is the content of the message input by the corresponding viewer as a message included in the corresponding collection of messages to the corresponding distributor, “character type” which is the type of a character that decorates the message on the collection of messages, “confirmed flag” indicating whether the message is confirmed or not, and “confirmed date and time” which is the date and time when the message has been confirmed.

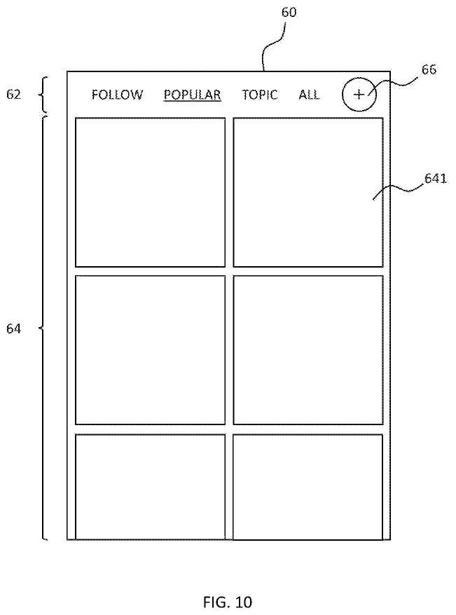

The information managed by each table has been described. Next, the basic operation of the live distribution service in this example will be described. FIG. 10 illustrates a top screen 60 of the live distribution service displayed on the user terminal 30. The screen 60 is a screen that serves as a starting point for a user who uses the live distribution service. As shown in the drawing, the screen 60 includes a selection area 62 where “follow”, “popular”, “topic”, and “all” are displayed, a list display area 64 located below the area 62 and a circular distribution button 66 located in the upper right corner of the screen.

The selection area 62 is an area for selecting the display content in the list display area 64. Specifically, when “follow” is selected in the selection area 62, a list of live distributions (videos being distributed) of other users that the user follows is displayed in the list display area 64. Similarly, when “popular” is selected in the selection area 62, a list of live distributions (for example, distributions of which the number (current value) of viewers is equal to or larger than a threshold value) extracted according to a predetermined extraction condition for extracting popular live distributions is displayed in the list display area 64. When “topic” is selected in the selection area 62, a list of tags assigned to live distributions is displayed in the list display area 64 in chronological order (in order of the assigned time) together with the corresponding distribution. When “all” is selected in the selection area 62, all live distributions are displayed as a list in the list display area 64.

The top screen 60 of FIG. 10 corresponds to the case where “popular” is selected in the selection area 62. In the list display area 64 in this case, as shown in the drawing, a plurality of individual display areas 641 each displaying information on an individual live distribution are arranged in two columns in the vertical direction. The individual display area 641 is configured so that the viewing of the corresponding distribution can be started (the play of the corresponding video is started) according to the selection by the user. The list display area 64 is configured so that the displayed individual display area 641 is switched by a flick operation or a slide operation in the vertical direction. The configuration of the list display area 64 when “follow” or “all” is selected in the selection region 62 is the same as the configuration described above when “popular” is selected.

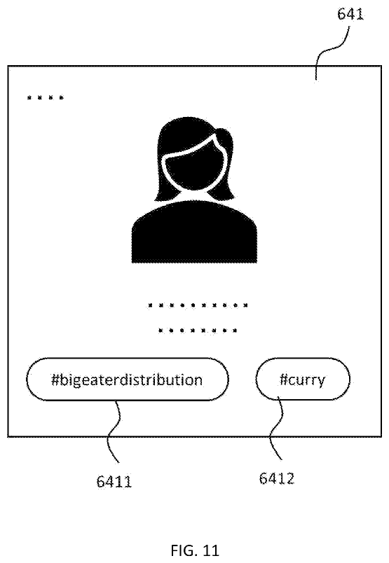

FIG. 11 illustrates the display content of the individual display area 641. The individual display area 641 displays an image preset by the distributor of the live distribution, the account name of the distributor, the number of viewers (current value), and the like. As shown in the drawing, at the lower end thereof, a first tag object 6411 and a second tag object 6412 are arranged side by side in the left-right direction. In the first tag object 6411, the classification text (managed in the user information table 411), which is the classification of the distributor set by the distributor, is displayed in a hashtag format (a format that adds “#” to the beginning of a character string) (in the example of FIG. 11, “#bigeaterdistribution” is displayed). In addition, in the second tag object 6412, the latest tag given by the viewer to the corresponding live distribution is displayed in the same hashtag format (in the example of FIG. 11, “#curry” is displayed).

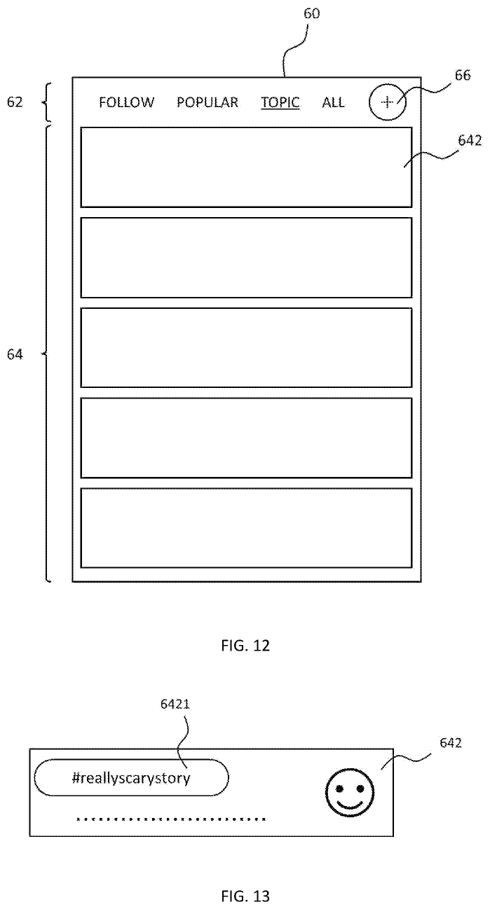

FIG. 12 illustrates the top screen 60 when “topic” is selected in the selection area 62. In this case, as shown in the drawing, the top screen 60 displays a list of tags assigned to a certain live distribution is displayed in the list display area 64 in chronological order together with the distribution. That is, in the list display area 64 when “topic” is selected in the selection area 62, a list of tags arranged in descending order of the assigned time and a list of corresponding live distributions (distributions to which the tag is assigned) are displayed.

In the list display area 64 in this case, a plurality of individual display areas 642, each displaying individual tags and information related to the corresponding live distribution, are arranged side by side in the vertical direction. When a new tag is added to a certain live distribution, the corresponding individual display area 642 is added to the top of the list display area 64.

FIG. 13 illustrates the display content of the individual display area 642. As shown in the drawing, the area 642 has a tag object 6421 arranged in the upper left corner, and displays a profile image, an account name, and the like of the distributor of the corresponding live distribution (the distribution to which the tag is assigned). A link to the corresponding live distribution is set in the individual display area 642, and the user can start viewing the corresponding distribution by selecting any one of the plurality of individual display areas 642 displayed in the list display area 64.

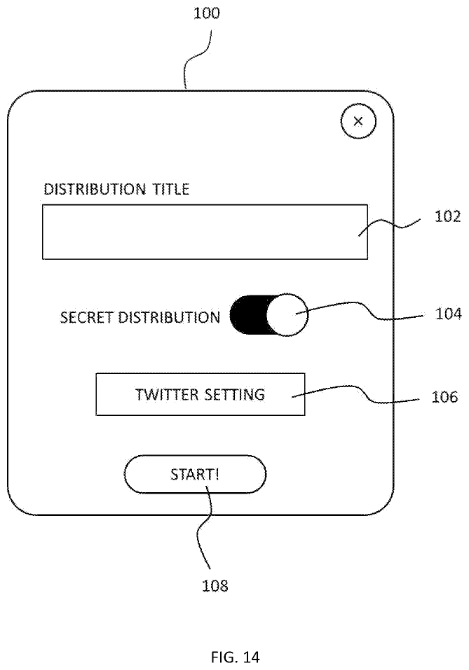

The distribution button 66 on the top screen 60 is an object for the user to perform live distribution of the video as a distributor. When the distribution button 66 is selected by the user, the distribution preparation screen 100 illustrated in FIG. 14 is displayed to be superimposed on the top screen 60. As shown in the drawing, the screen 100 includes a distribution title input area 102 for inputting a distribution title, a secret distribution setting switch 104 for setting a secret distribution mode, a twitter setting button 106 for making settings related to twitter (posting a message to SNS) performed automatically during distribution, and a distribution start button 108 displayed as “Start!”. The secret distribution is a distribution mode of live distribution that can be viewed only by new viewers (specifically, viewers whose total viewing time for a predetermined period for the corresponding distributor is less than a predetermined value).

When the distribution start button 108 is selected, live distribution is started. Specifically, transmission of a video configured of the image input through the camera of the user terminal 30 and the audio input via the microphone of the user terminal 30 to the server 10 is started. In addition, a new record is created in the distribution management table 412 according to the start of live distribution.

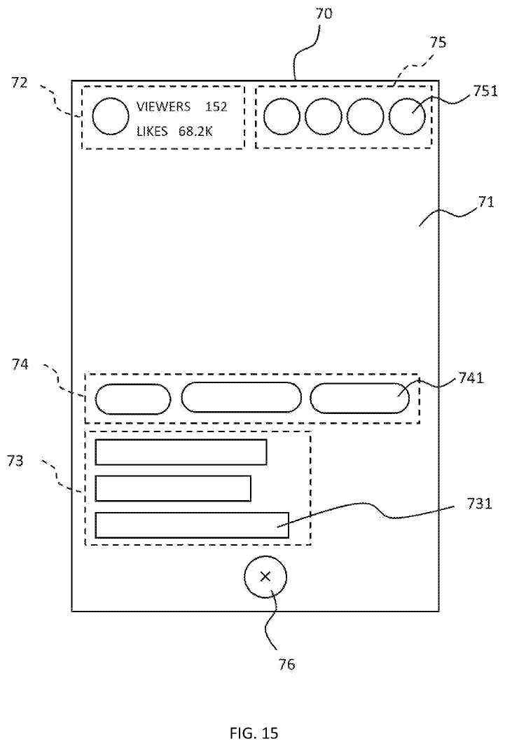

FIG. 15 illustrates a distributor screen 70 displayed on the distributor terminal 30 in response to the selection of the distribution start button 108 (that is, the start of live distribution). As shown in the drawing, the screen 70 has a video display area 71 corresponding to the entire screen, a basic information display area 72 located in the upper left corner of the screen, a comment display area 73 located in the lower left corner of the screen, a tag display area 74 located in the upper side of the area 73, a viewer information display area 75 located in the upper right corner of the screen, and a circular distribution stop button 76 located in the center of the lower end of the screen.

The video display area 71 displays a video to be live-distributed, that is, an image input via the camera of the distributor terminal 30. Since the distributor usually takes the distributor himself/herself as a subject via the in-camera or the like of the distributor terminal 30, the video to be distributed includes the image of the distributor himself/herself.

The basic information display area 72 displays the basic information of this distribution, and specifically, displays the distributor information (profile image and the like), the number of viewers (current value) of this distribution, and the number of “likes” input by the viewers for this distribution.

The comment display area 73 is an area for displaying the user comment input by the viewer or the system comment automatically input by the server 10. Specifically, in the area 73, a plurality of comment objects 731, each corresponding to an individual comment, are arranged side by side in the vertical direction. The comment display area 73 is configured so that, when a new comment is input, the corresponding comment object 731 is added to the lower side and the existing comment object 731 moves upward in order. The comment display area 73 is configured so that the displayed comment object 731 is switched by a flick operation or a slide operation in the vertical direction.

The tag display area 74 displays information on the tags assigned to the distribution. Specifically, in the area 74, a plurality of tag objects 741 each corresponding to an individual tag are arranged side by side in the left-right direction.

The viewer information display area 75 displays information on a plurality of viewers who are viewing the corresponding live distribution. Specifically, in the area 75, a plurality of icon objects 751 each corresponding to a viewer are arranged side by side in the left-right direction. The object 751 has a circular shape and displays a profile image of the corresponding viewer. The plurality of icon objects 751 are arranged in an order according to a predetermined rule, and for example, the viewer having a larger number of yell points described above is arranged on the left side.

The distribution stop button 76 is an object for the distributor to stop the live distribution. When the distribution stop button 76 is selected by the distributor, live distribution (transmission of a video from the distributor terminal 30 to the server 10) is stopped.

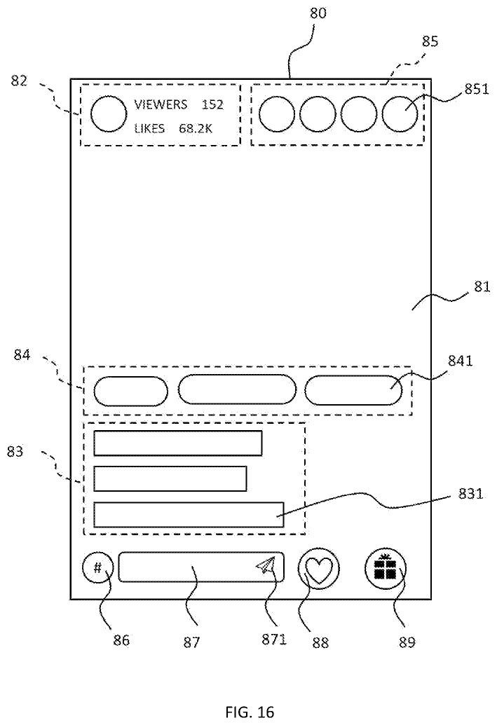

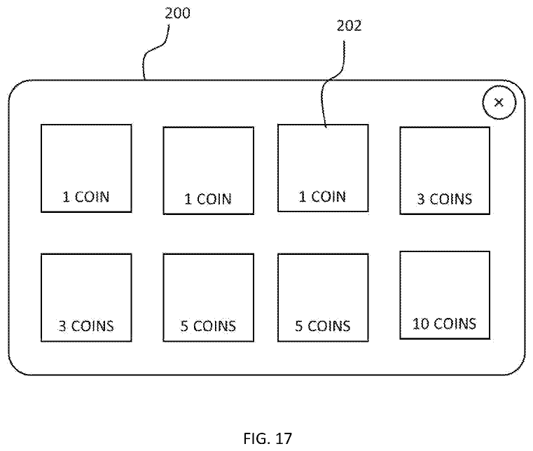

FIG. 16 illustrates a viewer screen 80 displayed on the viewer terminal 30. For example, when a certain live distribution is selected by the viewer via the list display area 64 or the like of the top screen 60, the viewer screen 80 for viewing the selected distribution is displayed on the viewer terminal 30. As shown in the drawing, the screen 80 has a video display area 81, a basic information display area 82, a comment display area 83, a tag display area 84, and a viewer information display area 85, similarly to the distributor screen 70 described above. Further, the viewer screen 80 includes, at the lower end of the screen, an input mode switching button 86, a comment input area 87, a “like” button 88 on which a heart mark is displayed, and an item input button 89 on which a gift pattern is displayed.

The comment input area 87 is an area for the viewer to input a comment or a tag. While the input mode switching button 86 is in the non-selected state, the comment input area 87 is in a normal comment input mode. In the comment input mode, when a transmission object 871 arranged at the right end of the comment input area 87 is selected, a character string input in the area 87 is transmitted as a user comment, and comment objects 731 and 831 corresponding to the user comment are added to the comment display areas 73 and 83 of the distributor screen 70 and the viewer screen 80 of the corresponding distributor terminal 30 (the user terminal 30 of the distributor of the live distribution being viewed) and the viewer terminals 30 (user terminals 30 of a plurality of viewers of the live distribution being viewed). In the comment objects 731 and 831 corresponding to the user comment, the content (character string) of the comment is displayed together with the account name of the viewer who input the comment. Further, when the user comment is transmitted, the server 10 updates (adds 1) the number of comments of the corresponding record in the distribution management table 412. Further, when the user comment is transmitted, the server 10 updates (adds 1) the number of input comments of the corresponding record in the relationship parameter management table 413.

When the input mode switching button 86 is selected, the comment input area 87 is in a tag input mode. In the tag input mode, when the transmission object 871 is selected, the character string input in the comment input area 87 is transmitted as a tag, and the tag is assigned to the live distribution. In this example, the viewers who can input tags are limited to the family members of the corresponding distributor. Specifically, the input mode switching button 86 on the viewer screen 80 can be selected (enabled) when the viewer is a family member of the distributor and cannot be selected (disabled) when the viewer is not a family member of the distributor. Further, in this example, the number of tags that can be assigned to one live distribution in a predetermined period is limited, and specifically, the number of tags that can be assigned in 5 minutes is three.

When the tag is added, the corresponding tag objects 741 and 841 are added in the tag display areas 74 and 84 of the corresponding distributor screen 70 and viewer screen 80. The tag objects 741 and 841 are arranged side by side in the tag display areas 74 and 84 so that the left side is newer (the assigned time is later). Therefore, the tag objects 741 and 841 corresponding to the newly added tag are added to the left end in the tag display areas 74 and 84. After 5 minutes pass since the corresponding tag has been added, the tag objects 741 and 841 are deleted (for example, they disappear with an animation effect of moving to the right).

The tag objects 741 and 841 in this example display the content of the tag in the hashtag format in which “#” is added to the beginning of the character string. For example, when the content of the tag is “Tokyo sightseeing”, “#tokyosightseeing” is displayed in the tag objects 741 and 841. The length of the tag objects 741 and 841 in the left-right direction is automatically adjusted according to the length of the character string to be displayed.

Further, when the tag is added, comment objects 731 and 831 corresponding to a system comment notifying of the addition of the tag are added in the comment display areas 73 and 83 of the corresponding distributor screen 70 and viewer screen 80. In the comment objects 731 and 831 corresponding to the system comment, the content of the added tag is displayed together with the account name of the viewer who has added (input) the tag. For example, a comment “xx tagged “#tokyosightseeing” to the distribution” is displayed. Further, when the tag is added, the tag information of the corresponding record in the distribution management table 412 is updated.

The like button 88 is an object for the viewer to input a “like” to the distributor (live distribution). When the button 88 is selected by the viewer, “like” is input, and the comment objects 731 and 831 corresponding to a system comment notifying of the input of “like” are added in the comment display areas 73 and 83 of the corresponding distributor screen 70 and viewer screen 80. In the comment objects 731 and 831 corresponding to the system comment, a text indicating the input of “like” is displayed together with the account name of the viewer who has input the “like”. Further, when “like” is input, the corresponding visual effect (for example, an animation effect that a heart-shaped object is displayed to move from the lower side to the upper side of the screen) is added in the video display areas 71 and 81 of the distributor screen 70 and the viewer screen 80. Further, when “like” is input, the server 10 updates (adds 1) the “number of likes” of the corresponding record in the distribution management table 412.

The item input button 89 is an object for the viewer to input an item. When the button 89 is selected by the viewer, the item selection screen 200 illustrated in FIG. 17 is displayed to be superimposed on the viewer screen 80. As shown in the drawing, the screen 200 displays a list of a plurality of individual display areas 202, each displaying information on an item. The individual display area 202 displays an image corresponding to the item and the number of coins required for inputting the item.

In this example, a plurality of items that can be input by the viewer are determined in advance, and the number of coins as the price (which can also be called value or reward) is set in advance for each item. The item selection screen 200 displays a list of a plurality of items that can be input. When a certain item is selected by the viewer via the item selection screen 200, the selected item is input.

When an item is input, the comment objects 731 and 831 corresponding to a system comment notifying of the input of the item are added in the comment display areas 73 and 83 of the corresponding distributor screen 70 and viewer screen 80. In the comment objects 731 and 831 corresponding to the system comment, the name of the input item is displayed together with the account name of the viewer who has input the item. Further, when an item is input, a visual effect corresponding to the input item is added in the video display areas 71 and 81 of the corresponding distributor screen 70 and viewer screen 80. Further, when an item is input, the server 10 assigns the number of item points (for example, the larger the number of coins, the larger the number of points) corresponding to the number of coins of the input item to this distribution. Specifically, in the distribution management table 412, the number of points corresponding to the number of coins is added to the number of item points of the corresponding record. When an item is input, the server 10 subtracts the number of coins of the input item from the number of holding coins in the corresponding record (record of the viewer who has input the item) in the user information table 411. When an item is input, the server 10 adds the number of coins of the input item to the number of consumed coins of the corresponding record in the relationship parameter management table 413.

Further, when the viewer newly starts viewing (enters a live distribution room), the comment objects 731 and 831 corresponding to the system comment notifying of the viewer's entry are added in the comment display areas 73 and 83 of the corresponding distributor screen 70 and viewer screen 80. In the comment objects 731 and 831 corresponding to the system comment, the account name and the like of the user who has started viewing (has entered the room) is displayed. Further, when the current viewing is the first viewing on the day of the live distribution of the corresponding distributor, the server 10 updates (adds 1) the number of viewing days of the corresponding record in the relationship parameter management table 413.

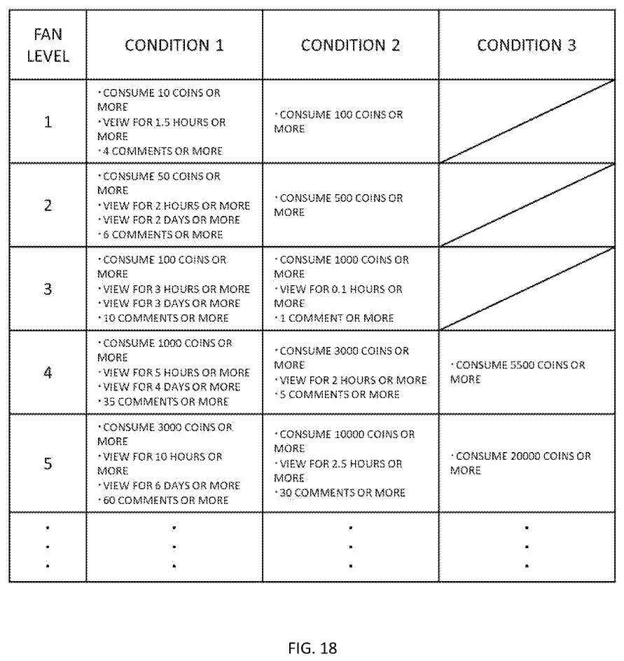

The basic operation of the live distribution service has been described above. Next, the operation related to the management of the fan level of the viewer with respect to the distributor will be described. FIG. 18 is a diagram for explaining the condition of each of the plurality of fan levels in this example. As shown in the drawing, in this example, two or three conditions are set for each fan level, and a user who satisfies any one of these two or three conditions has a corresponding fan level (the level goes up). For example, the fan level of “1” includes two conditions including condition 1 that “consume 10 coins or more, view for 1.5 hours or more, and input 4 comments or more”, and condition 2 that “consume 100 coins or more”. A user who satisfies any one of these two conditions becomes a viewer with the fan level of “1”. Further, for example, the fan level of “4” includes three conditions including condition 1 “consume 1000 coins or more, view for 5 hours or more, view for 4 days or more, and input 35 comments or more”, condition 2 that “consume 3000 coins or more, view for 2 hours or more and input 5 comments or more” and condition 3 that “consume 5500 coins or more”. A user who satisfies any one of these three conditions becomes a viewer with the fan level of “4”.

In this example, the condition corresponding to the fan level may vary on the basis of the distributor information on the distributor, the viewer information on the viewer, the combination information on the combination of the distributor and the viewer, or the like. For example, the lower the rank of the distributor, the easier it is to satisfy the condition corresponding to the fan level (for example, the lower the condition value). Further, for example, the condition corresponding to the fan level varies depending on the viewer's area of residence (for example, the condition of the viewer in a specific residential area is easily satisfied). Further, for example, the condition corresponding to the fan level is easily satisfied in the target year and month when the live distribution of the corresponding distributor is first viewed.

Such a fan level is determined in real-time during live distribution. Specifically, during live distribution, the server 10 updates the number of consumed coins, the viewing time, the number of viewing days, and the number of input comments in the relationship parameter management table 413 for each viewer in real-time, and determines whether the fan level has been raised on the basis of these pieces of information. As the fan level rises, the value of the fan level of the corresponding record in the relationship parameter management table 413 is updated.

In this example, a decoration corresponding to the fan level of the viewer is made on the comment objects 731 and 831 corresponding to the viewer's actions (specifically, entry (start of viewing), and input of comment, tag, like, and item). For example, an icon corresponding to the fan level of the viewer is added to the comment objects 731 and 831, and a character color corresponding to the fan level is applied.

In this example, a predetermined higher fan level may be invalidated for a certain period from the start point of each month and may be effective from a specific timing in the middle of the month. In this case, for example, a viewer who satisfies the condition corresponding to the fan level effective at a specific timing (for example, 15th) of each month before the fan level becomes effective is not raised to this fan level until the fan level becomes effective (until a specific timing is reached). In this way, it is possible to prevent the number of high-ranking fan-level viewers from increasing excessively early in each month and other general viewers from being deflated.

The operation related to the management of the fan level of the viewer with respect to the distributor has been described above. Next, the operation when the distributor ends the live distribution will be described. As described above, when the distributor selects the distribution stop button 76 on the distributor screen 70, the live distribution ends. When the live distribution ends, the server 10 calculates and sets the number of distribution points for the distribution. In this example, the number of distribution points is calculated on the basis of the number of viewers (maximum value), the number of likes, the number of comments, and the number of item points. The number of distribution points increases as the number of viewers (maximum value), the number of likes, the number of comments, and the number of item points increase. The calculated number of distribution points is set in the corresponding record in the distribution management table 412.

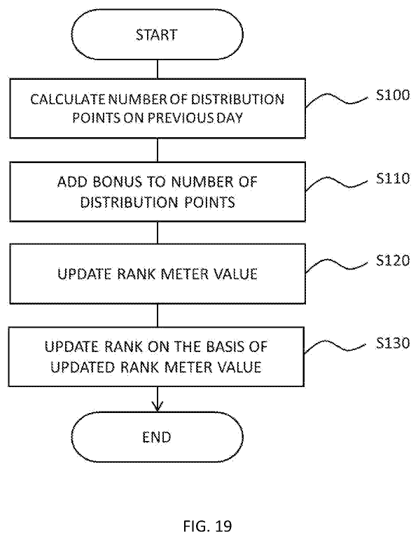

The operation when the distributor ends the live distribution has been described above. Next, the operation when determining the rank of the distributor will be described. In this example, the rank of the day is determined (updated) on the basis of the number of distribution points acquired by the user on the previous day. FIG. 19 is a flowchart illustrating processes executed by the server 10 when updating the rank of each user. These processes are performed daily at midnight (for example, 3 AM daily).

First, as shown in the drawing, the server 10 calculates the number of distribution points acquired by each user on the previous day (step S100). The number of distribution points acquired by a specific user on the previous day is calculated by referring to the distributor user account, the distribution start date and time, and the number of distribution points in the distribution management table 412. When the user performs a plurality of distributions in one day, the numbers of distribution points acquired in the plurality of distributions are added up.

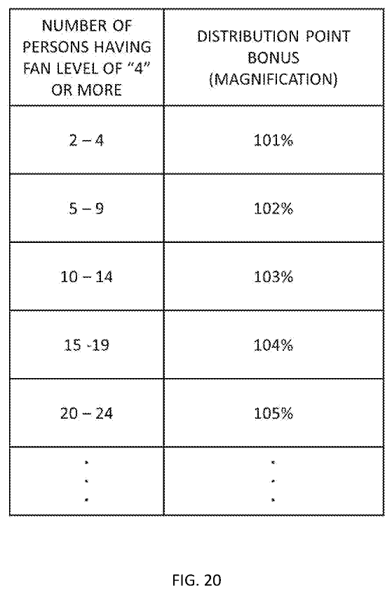

When the number of distribution points on the previous day of each distributor is calculated in this way, the server 10 subsequently adds a bonus to the number of distribution points (step S110). Specifically, in this example, a bonus is added to the number of distribution points according to the number of “special fans” whose fan level is “4” or higher. FIG. 20 illustrates the correspondence between the number of special fans and the distribution point bonus (magnification). In this example, as shown in the drawing, when the number of special fans is 2 to 4, the number of distribution points is 101% (multiplied by 1.01) as a distribution point bonus. In other words, if the number of special fans is 2 to 4, 1% of the calculated number of distribution points will be added as a bonus. Similarly, when the number of special fans is 5 to 9, the distribution point bonus (magnification) is 102%, and then the distribution point bonus (magnification) increases as the number of special fans increases, which is advantageous for the distributor.

Further, in this example, a bonus is added to the distribution points according to the total of the numbers of yell points of the plurality of viewers. For example, if the total number of yell points is 5000 points or more, a bonus of 500 points will be added to the distribution points, and if the total value of the number of yell points is 10,000 points or more, a bonus of 1000 points will be added to the distribution points. The bonus increases as the number of yell points increases, which is advantageous for the distributor. In another example of the present embodiment, the bonus of distribution points based on the number of yell points is not applied, and only the bonus of distribution points based on the number of special fans may be applied. Furthermore, instead of or in addition to the bonus of distribution points based on the number of special fans, the bonus may be added to the distribution points based on the total value of the fan level values of the viewers.

Further, the addition of the bonus to the distribution points is one example of a reward to the distributor. In another example of this embodiment, various rewards can be given to the distributor based on the fan level of each of the plurality of viewers. For example, as a reward to the distributor, a bonus may be added to the reference number of diamonds described below, or the right to participate in a special event may be given to the distributor.

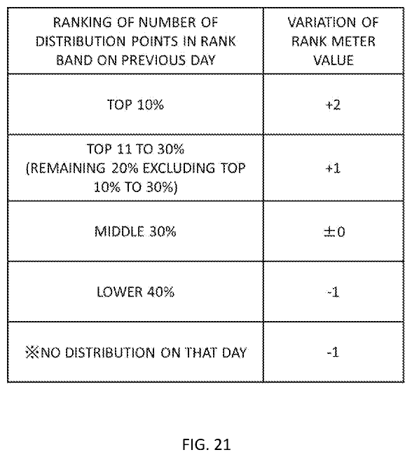

When the bonus for the number of distribution points is added in this way, the server 10 then updates the rank meter value of each user (step S120). FIG. 21 is a diagram for explaining the update rule of the rank meter value. As shown in the drawing, in this example, the rank meter value varies on the basis of the ranking of the number of distribution points of each user on the previous day in the rank band to which the user belongs.

Specifically, as shown in FIG. 21, the rank meter value update rule is as follows. First, when the ranking of the number of distribution points in the rank band is included in the top 10%, the variation of the rank meter value is “+2” (increased by 2 points). Similarly, the variation is “+1”, when the ranking is included in the top 11% to 30% (the remaining 20% excluding the top 10% to the top 30%), the variation is “±0” (not changed) when the ranking is the middle 30% (the top 31% to 60%), and the variation is “−1” (decreased by 1 point) when the ranking is included in the lower 40%. If no distribution is performed in the previous day, the variation of the rank meter value will be “−1” regardless of the ranking in the rank band.

In step S120, the rank meter value of each user is updated according to the update rule illustrated in FIG. 21.

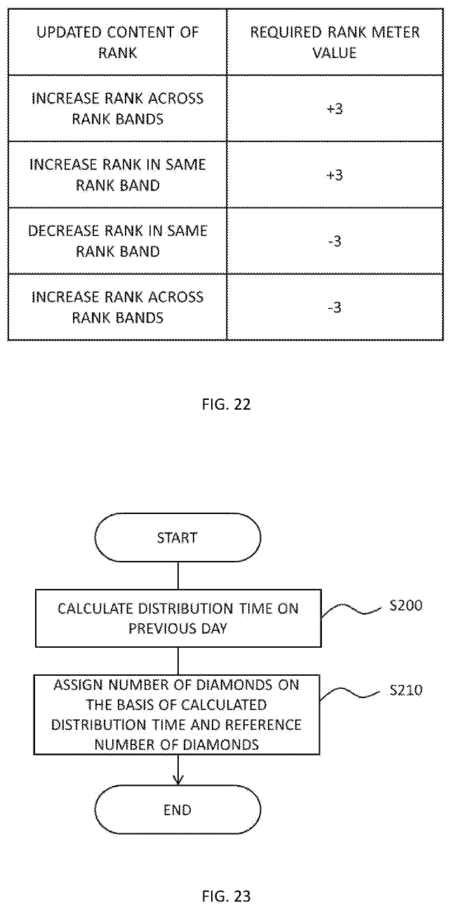

Returning to the flowchart of FIG. 19, when the rank meter value of each user is updated, the server 10 then updates the rank on the basis of the updated rank meter value (step S130). FIG. 22 is a diagram for explaining the correspondence between the updated content of the rank and the required rank meter value. As shown in the drawing, the rank meter value required for increasing the rank across rank bands (in other words, for a user to move up in the ranks from the highest rank in each rank band) and for increasing the rank within the same rank band (in other words, for a user to move up in the ranks from the rank other than the highest rank in each rank band) is +3. That is, when the rank meter value reaches +3, the user belonging to the highest rank (for example, A3) in each rank band moves up in the ranks to the lowest rank (for example, S1) in the rank band immediately above. Further, when the rank meter value reaches +3, the user belonging to the rank other than the highest rank (for example, B2 or B1) in each rank band moves up in the ranks to a rank (for example, B3 or B2) immediately above in the same rank band.

Similarly, as illustrated in FIG. 22, the rank meter value required for decreasing the rank within the same rank band (in other words, for a user to move down in the ranks from the rank other than the lowest rank in each rank band) and for decreasing the rank across rank bands is −3. That is, when the rank meter value reaches −3, the user belonging to the rank other than the lowest rank (for example, B3 or B2) in each rank band moves down in the ranks to a rank (for example, B2 or B1) immediately below in the same rank band. Further, when the rank meter value reaches −3, the user belonging to the lowest rank (for example, A1) in each rank band moves down in the ranks to the highest rank (for example, B3) in the rank band immediately below. As described above, in this example, the required rank meter values are equal for increasing or decreasing the rank across the rank bands and increasing or decreasing the rank within the same rank band. However, in another example, the absolute value of the rank meter value required for increasing or decreasing the rank across the rank bands may be larger than that required for increasing or decreasing the rank within the same rank band to suppress increasing or decreasing the rank rapidly in a short period of time.

In step S130, the rank based on the rank meter value is updated according to the correspondence illustrated in FIG. 22. The rank meter value of the user whose rank has been updated (the user whose rank has been increased or decreased) is cleared to 0.

The operation for determining the rank of the distributor has been described above. Next, the operation when giving a diamond to the user will be described. In this example, a diamond, which is a reward for the user as a distributor, is given on the basis of the distribution time of the previous day and the rank (the rank on the previous day). FIG. 23 is a flowchart illustrating processes executed by the server 10 when assigning a diamond to each distributor. These processes are executed at midnight every day, for example, is executed at a time (for example, 0 o'clock AM every day) before the processing executed when updating the rank of each user illustrated in FIG. 19.

First, the server 10 calculates the distribution time of each user on the previous day as shown in the drawing (step S200). The distribution time of the previous day of a specific user is specifically calculated by referring to the distributor user account, the distribution start date and time, and the distribution time in the distribution management table 412. When the user performs a plurality of distributions in one day, the distribution times of the plurality of distributions are added up.

Subsequently, the server 10 assigns each user the number of diamonds based on the calculated distribution time and a reference number of diamonds (step S210). Specifically, each user is given the number of diamonds obtained by multiplying the calculated distribution time by the reference number of diamonds. The reference number of diamonds is set in advance for each rank so that the higher the rank, the larger the reference number of diamonds, and the reference number of diamonds corresponding to the rank of each user on the previous day is applied. When a diamond is given to the user, the number of holding diamonds in the corresponding record in the user information table 411 is updated. In this example, diamonds can be exchanged with coins or real currency.

The operation when giving a diamond to the user has been described above. Next, the operation when creating a collection of messages as message content will be described. In this example, as described above, an event for creating a collection of messages for the distributor is held four times a year.

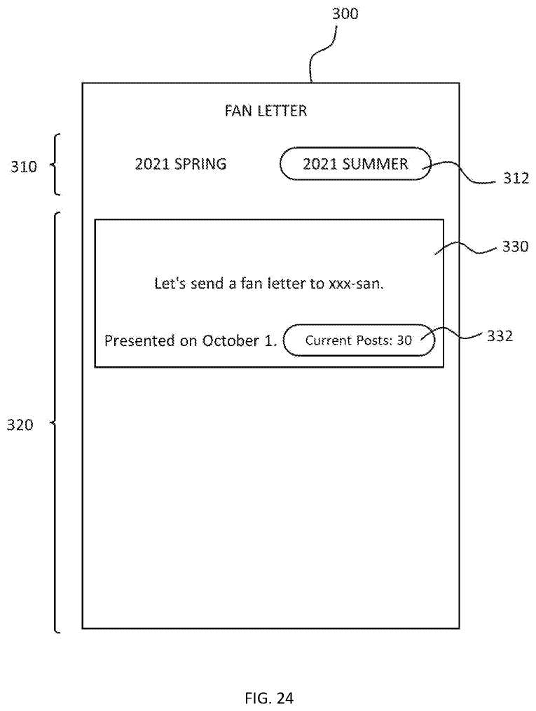

FIG. 24 illustrates a fan letter screen 300. In this example, the screen 300 is a screen for starting to view a collection of messages (fan letter) for a specific distributor and to edit a message for the collection of messages. For example, the fan letter screen 300 corresponding to the specific distributor is displayed via a profile screen of the specific distributor or the screen for the family member of the specific distributor. Further, in this example, only the special fan of the corresponding distributor (that is, the viewer whose fan level is “4” or higher) can input a message. The fan letter screen 300 is displayed on the user terminal 30 of the corresponding distributor and the special fan of the distributor but is not displayed on the user terminals 30 of other viewers who are not the special fan.

As shown in the drawing, the fan letter screen 300 has a selection area 310 for selecting the type (in this example, a combination of calendar year and season) of a collection of messages and an information display area 320 located below the area 310, for displaying information corresponding to the collection of messages selected via the area 310.

The selection area 310 is configured to be able to select one collection of messages from the collections created so far and the collection (the collection of messages during the message input reception period) being created at that time. The area 310 is configured so that the displayed selectable collection of messages is switched by a flick operation or a slide operation in the horizontal direction. In the fan letter screen 300 of FIG. 24, the collection of messages corresponding to “2021 SUMMER” is selected in the selection area 310. In this example, the corresponding distributor can select only the collections of messages created so far (published collections of messages) in the selection area 310 and cannot select the collection of messages being created (the collection of messages is not displayed in the selection area 310).

The fan letter screen 300 of FIG. 24 corresponds to a state in which the collection of messages (2021 summer) selected via the selection area 310 is being created (that is, in the middle of the period from the reception start date and time of the message input to the reception end date and time). In this case, as shown in the drawing, an object 330 corresponding to a collection of messages being created is arranged in the information display area 320.

As shown in the drawing, the object 330 corresponding to the collection of messages being created displays a text “Let's send a fan letter to xxx-san” (“xxx” is the account name of the distributor) and information on the viewable date (a text “Presented on October 1”). A display object 332 corresponding to the number of input viewers is arranged in the lower right corner thereof. The object 332 displays the number of messages input at that time (30 in the example of FIG. 24). In this example, one viewer can input one message, and the number of input messages means the number of viewers who input the message. In another example of the present embodiment, one viewer may be able to input a plurality of messages. In addition, in this example, the viewable date of the collection of messages is set to the day after the end date and time of receiving the input of the message.

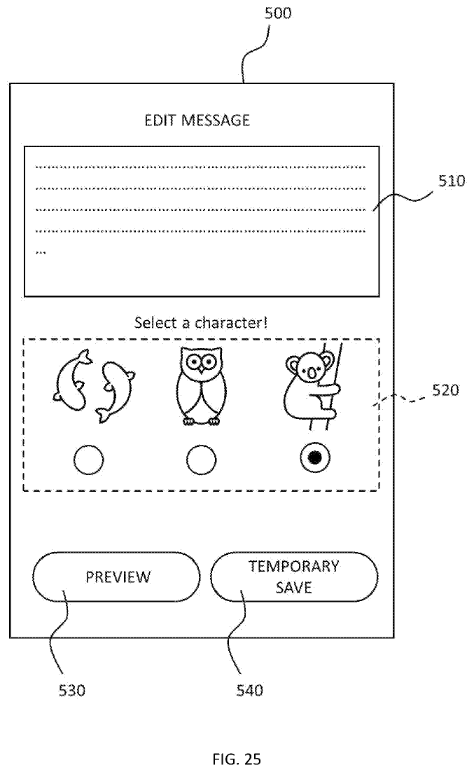

When the object 330 corresponding to the collection of messages being created is selected, a message editing screen 500 shown in FIG. 25 is displayed instead of the fan letter screen 300. As shown in the drawing, the screen 500 has a message input area 510 for inputting the content of the message, a character selection area 520 for selecting the type of a character to decorate the message on the collection of messages, a preview button 530, and a temporary save button 540.

In this example, the upper limit of the number of characters included in the message is set for each fan level. Specifically, the upper limit of the number of characters increases as the fan level increases. The message input area 510 is configured so that a message can be input within the range of the upper limit of the number of characters corresponding to the fan level of the corresponding viewer.

When the temporary save button 540 is selected, the content of the message input via the message input area 510 and the type of the character selected via the character selection area 520 are temporarily saved. Specifically, a new record is created in the message management table 415, and a value corresponding to each field is set. In this case, a value indicating “unconfirmed” is set in the confirmed flag. After the temporary saving is performed, the temporarily saved content is reflected on the screen 500 at the next display of the message editing screen 500.

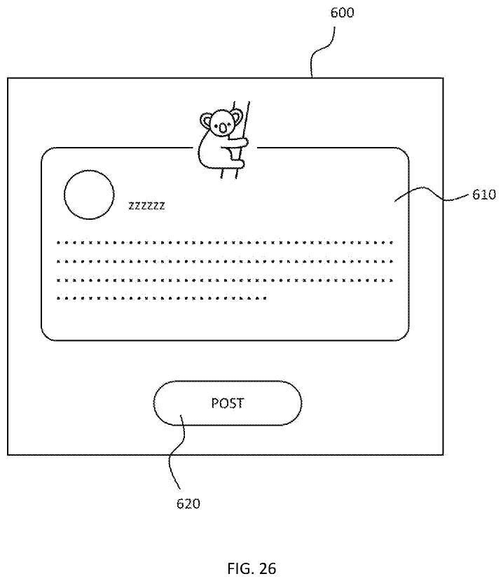

When the preview button 530 is selected, a preview screen 600 illustrated in FIG. 26 is superimposed on the message editing screen 500. As shown in the drawing, the screen 600 has a message object 610 and a post button 620 located below the object 610. The message object 610 is an object showing the appearance of the message to be reflected in the collection of messages, and the content input via the message editing screen 500 at that time is reflected. Specifically, the message object 610 reflects the content of the message input at that time, and the selected character is arranged at the upper end thereof. Further, the message object 610 displays the profile image and the account name of the corresponding viewer. The viewer can see the appearance of the actual message to be reflected in the collection of messages through the object 610.

When the post button 620 is selected, the viewer's input of the message is confirmed. Specifically, in the message management table 415, the value corresponding to each field is set for the corresponding record (record created according to temporary saving or newly created record when temporary saving has not been performed). In this case, a value indicating “confirmed” is set in the confirmed flag. In this example, the once confirmed message cannot be edited, but the corresponding viewer can see the confirmed message via the message editing screen 500.

Such reception of the input of the message from a viewer is continued until the reception period of the input of the message ends. Then, when the reception period ends, the corresponding collection of messages is created and published.

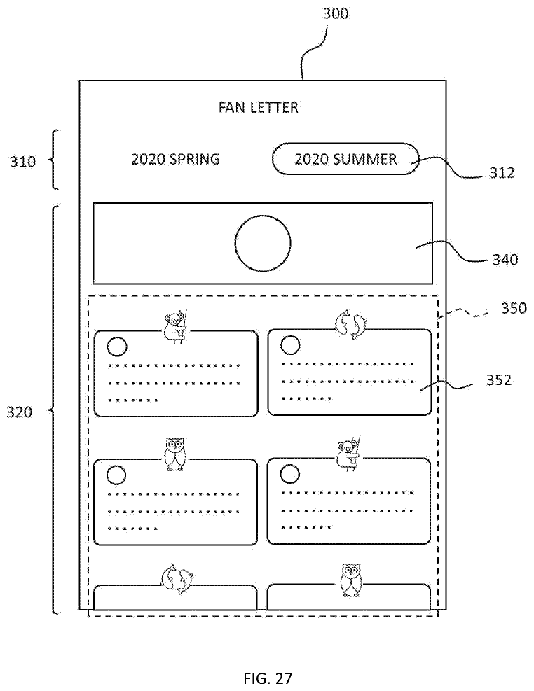

FIG. 27 illustrates a fan letter screen 300 in which a created published collection of messages is selected in the selection area 310. As shown in the drawing, in the fan letter screen 300, the published collection of messages is displayed in the information display area 320. Specifically, in the information display area 320, a header area 340 constituting the header of the published collection of messages and a main body area 350 which is located below the area 340 and constitutes the main body of the collection of messages are arranged.

A profile image of the distributor is arranged at the center of the header area 340. The background image of the header area 340 has a design corresponding to the type of the collection of messages.

In the main body area 350, a plurality of message objects 352, each corresponding to an individual message, are arranged side by side in two rows in the vertical direction. The message object 352 has the same appearance as the message object 610 of the preview screen 600. The background image of the main body area 350 has a design corresponding to the type of the collection of messages.

The plurality of message objects 352 in the main body area 350 is arranged in descending order of the number of yell points of the corresponding viewers. Specifically, in the main body area 350, the message object 352 corresponding to the viewer (the message input by the viewer) having the largest number of yell points is arranged on the left side of the first line from the top, the message object 352 corresponding to the viewer having the second largest number of yell points is arranged on the right side of the first line from the top, the message object 352 corresponding to the viewer having the third largest number of yell points is arranged on the left side of the second line from the top, and then the message objects 352 are arranged in the same manner. In this example, when the viewer who has input a message for the corresponding collection of messages views the collection of messages, the message object 352 corresponding to the viewer is arranged at the highest position (on the left side of the top line) regardless of the yell points of the viewer.

The arrangement of the message object 352 described above is an example of a method of arranging the message objects 352 based on the number of yell points of the corresponding viewers. In another example of the present embodiment, various other methods are applied to arrange (control the position and size of) the message objects based on the number of yell points. For example, a plurality of message objects may be arranged in a predetermined region (for example, a circular region), and a corresponding message object may be arranged so that the larger the number of yell points of the viewer, the closer it is located to the center of the region. Further, for example, a plurality of message objects may be arranged in a 3D space (for example, arranged in a 3D reel shape), and a corresponding message object may be arranged so that the larger the number of yell points of the viewer, the closer it is located to the front side.

In this example, when the number of input messages (that is, the number of viewers who have input the message) is equal to or more than a predetermined value (for example, 5), the collection of messages is created and published. When the number of input messages is less than the predetermined value, the collection of messages is not created and published (for example, a predetermined image is displayed in the information display area 320 of the fan letter screen 300).

In this example, the created collection of messages is published to all special fans of the distributor in addition to the corresponding distributor. In addition, in another example of the present embodiment, the created collection of messages is published only to the viewer who has input the message among the special fans. Further, in still another example of the present embodiment, the created collection of messages may be published to all users.

In the above-mentioned example, the distributor may be able to edit the collection of messages for the distributor himself/herself. For example, in a predetermined period before the publication of the created collection of messages or a predetermined period after the publication, the distributor may be able to delete (or hide) the messages included in the collection of messages and the distributor may be able to input a comment or a stamp (image). The comment or the like input by the distributor is arranged in, for example, the header area 340 constituting the header of the collection of messages.

In the above-mentioned example, only special fans having a fan level of “4” or higher can input a message for collection of messages, the upper limit of the number of characters included in the message is set based on the fan level, and the message objects 352 are arranged in the published collection of messages based on the number of yell points. However, the “fan level” and the “number of yell points” are examples of the relationship parameter related to the relationship between the distributor and the viewer. In another example of the present embodiment, the input of the message and the arrangement of the messages may be controlled based on the value of another parameter. For example, a family member of the corresponding distributor may be able to input a message for the collection of messages. In addition, the control based on the value of the relationship parameter includes control other than the control of the input of the message and the control of the arrangement of the messages, and various controls related to the creation of the collection of messages may be performed based on the value of the relationship parameter.

In the above-mentioned example, the message is decorated with a character, but instead of or in addition to this, various images (including photographs) may be used to create and edit the message object 352. For example, such an image is used as the decoration, background, and body of the message. Further, for example, such an image is selected from images prepared in advance by the management of the live distribution service or is selected from images owned by the viewer.

In the above-mentioned example, the message for collection of messages is composed of text, but it may be composed of videos or audios. In this case, the format of the message content is not limited to the above-mentioned collection of messages and may be configured as content in various formats. For example, the message content may be composed of a combination of videos or audios that are continuous in time, and in this case, the temporal position of the corresponding message (video or audio) may be determined according to the number of yell points of the viewer.

In the above-mentioned example, when the number of viewers who input the message is large, the generated collection of messages may be divided. For example, even in the middle of the message input reception period, a divided collection of messages may be generated each time the number of input messages reaches a predetermined value (for example, 30). Alternatively, if the number of messages is equal to or greater than a predetermined value at the end of the message input reception period, the collection of messages may be generated and then divided. In this case, the messages included in each of the plurality of collections of messages are assigned according to the fan level of the viewer (the messages are divided into a collection of messages corresponding to a viewer with a higher fan level and a collection of messages corresponding to a viewer with a lower fan level). The divided collection of messages may be individually selectable as another type of collection of messages, for example, via the selection area 310 of the fan letter screen 300.

In the above-mentioned example, the message of the viewer blocked by the distributor may not be displayed in the collection of messages. For example, a message input by a blocked viewer may be included in the collection of messages when viewed by this viewer but may not be included in the collection of messages when viewed by another user.

In the above-mentioned example, during the message input reception period, the viewer who is the special fan and has not confirmed the input of the message may be prompted to input the message. For example, during the period, the viewer who is the special fan and has finished viewing the live distribution of the corresponding distributor may be guided to the message editing screen 500 for editing the message for collection of messages for the distributor (the screen 500 may be displayed on the viewer terminal 30). Further, the guidance to the message editing screen 500 may be performed when the live distribution is viewed to the end.

In the above-mentioned example, the reception of the message input may not be started for the distributor whose number of special fans is less than a predetermined value. In this case, for example, a predetermined image is displayed in the information display area 320 of the fan letter screen 300 corresponding to the distributor even during the message input reception period.

In the above-described example, a live distribution service enabling users to distribute and view a live video configured of an image input via the camera of the distributor terminal 30 and an audio input via a microphone of the distributor terminal 30 is provided. However, in another example of the present embodiment, an on-demand-type video distribution service that stores a video provided by the distributor in advance and distributes the video individually in response to the request from the viewer is provided.

The video distribution server 10 of the present embodiment described above generates the message content (the collection of messages) including a plurality of messages for the distributor input by the viewer based on the value of the relationship parameter (the fan level and the number of yell points) related to the relationship between the viewer and the distributor. Therefore, the generated message content takes the relationship between the viewer and the distributor into consideration. In this way, the video distribution server 10 supports the generation of content in consideration of the relationship between users.

In the above-described embodiment, message content including messages input by a viewer for a distributor in a video distribution service is generated. In another embodiment of the present invention, message content including messages input by a second user for a first user in other services may be generated. For example, in a community service (including an online salon), the input of messages by a participant (second user) in the community for an owner (first user) of the community may be received, and the message content including the messages may be generated. The message content may be generated based on the value of the relationship parameter (rank, level, and the like) related to the relationship between the owner and the participants in the community.

The processes and procedures described in the present specification are implemented by software, hardware, or any combination thereof, in addition to those expressly described. For example, the processes and procedures described in the present specification are realized by implementing logic corresponding to the processes and procedures on a medium such as an integrated circuit, a volatile memory, a non-volatile memory, or a magnetic disk. Further, the processes and procedures described in the present specification can be implemented as a computer program corresponding to the processes and procedures and executed by various computers.

Even if it is explained that the processes and procedures described in the present specification are executed by a single device, software, component, module, such processes or procedures may be executed by multiple devices, multiple pieces of software, multiple components, and/or multiple modules. The software and hardware components described in the present specification can also be realized by integrating them into fewer components or by breaking them down into more components.

In the present specification, even when the components of the invention are described as either singular or plural, or the components of the invention are described without limitation to either singular or plural, the components may be either singular or plural except that they should be understood separately in the context.

What is claimed is:

1. A system comprising one or more computer processors that execute machine-readable instructions to perform:
managing a value of a predetermined parameter related to a relationship with a first user and associated with each of a plurality of second users; and
generating content including a plurality of messages for the first user input by at least some of the plurality of second users, wherein
the generating of the content includes generating the content based on at least the value of the predetermined parameter of at least some of the plurality of second users.

2. The system according to claim 1, wherein the generating of the content includes generating the content so that a message input by the second user having a stronger relationship indicated by the value of the predetermined parameter is prioritized.

3. The system according to claim 2, wherein the generating of the content includes receiving the input of the message from the second user whose value of the predetermined parameter is within a predetermined range, while not receiving the input of the message from the second user whose value of the predetermined parameter is outside the predetermined range.

4. The system according to claim 2, wherein the generating of the content includes generating the content so that an amount of information of the message input by the second user having a stronger relationship indicated by the value of the predetermined parameter is larger.

5. The system according to claim 2, wherein the generating of the content includes generating the content so that the message input by the second user having a stronger relationship indicated by the value of the predetermined parameter is preferentially arranged.

6. The system according to claim 1, wherein the generating of the content includes limiting the number of messages that can be input by one second user to a predetermined value.

7. The system according to claim 1, wherein the generating of the content includes excluding a message input by the second user set to a predetermined state by the first user.

8. The system according to claim 1, wherein the generating of the content includes presenting the generated content to at least the first user.

9. The system according to claim 8, wherein the generating of the content includes stopping the presentation of the content to the first user when the number of second users who have input messages is less than a first predetermined value.

10. The system according to claim 1, wherein the generating of the content includes starting to receive the input of messages from the plurality of second users in response to the start of a predetermined period and generating the content including the plurality of messages input by the end of the predetermined period.

11. The system according to claim 1, wherein the generating of the content includes generating the divided content when the number of second users who have input messages is greater than a second predetermined value.

12. The system according to claim 1, wherein the content is a collection of messages.

13. The system according to claim 1, wherein
the first user is a distributor of a live video, and
each of the plurality of second users is a viewer of the live video.

14. The system according to claim 13, wherein
the managing of the value of the predetermined parameter includes updating the value of the predetermined parameter of each of the plurality of viewers so that the value increases as the live video provided by the distributor is viewed more, and
the generating of the content includes generating the content so that a message input by a viewer having a larger value of the predetermined parameter is prioritized.

15. A method performed by one or more computers, comprising:
managing a value of a predetermined parameter related to a relationship with a first user and associated with each of a plurality of second users; and
generating content including a plurality of messages for the first user input by at least some of the plurality of second users, wherein
the generating of the content includes generating the content based on at least the value of the predetermined parameter of at least some of the plurality of second users.

16. A non-transitory computer-readable medium including a program, the program causing one or more computers to execute:
managing a value of a predetermined parameter related to a relationship with a first user and associated with each of a plurality of second users; and
generating content including a plurality of messages for the first user input by at least some of the plurality of second users, wherein
the generating of the content includes generating the content based on at least the value of the predetermined parameter of at least some of the plurality of second users.
